(19) United States
(12) Patent Application Publication
(10) Pub. No.: US 2003/0233855 A1
(43) Pub. Date: Dec. 25, 2003

(54) Apparatus for securing moveable objects within a support rack

(76) Inventor: Rubin Pirveysian, Glendale, CA (US)

Correspondence Address: THE HECKER LAW GROUP, 1925 CENTURY PARK EAST, SUITE 2300, LOS ANGELES, CA, 90067, US

(21) Appl. No.: 10/177,957

(22) Filed: Jun. 21, 2002

(51) Int. Cl. E05B 73/00

(52) U.S. Cl. 70/62

(57) ABSTRACT

An apparatus embodying one or more aspects of the invention secures moveable objects such as computer hardware into position within a support rack by blocking one or more points of ingress and/or egress from the rack. An embodiment of the invention provides a mechanism for securing the moveable object into a fixed position within a support rack or any other system for holding such hardware. When the moveable object is locked within the support rack using the invention, an unauthorized party cannot move the physical object held within the support rack. In one or more embodiments of the invention, a constraining apparatus and a locking apparatus are disposed to control access and prevent the addition or removal of contents within an object. In one or more embodiments of the invention, a constraining apparatus and a locking apparatus are disposed to control access and prevent the addition or removal of contents within an object.

### FIELD OF THE INVENTION

This invention relates to the field of securing mounted devices. More specifically embodiments of the invention disclose an apparatus for securing computer hardware into a fixed position within a rack mount or any other system for holding computer hardware.

### BACKGROUND

Computer systems, particularly network server equipment can be stored in racks. The rack provides a location for storing multiple pieces of equipment in a manner that is easily accessible to network administrators or other technical people who require access to the equipment. The majority of racks are designed so that computer equipment can be freely moved from the rack during servicing or maintenance. When computer equipment is to be replaced it can simply be removed from the rack and replaced with another piece of equipment. Any combination of hardware components can be added to the rack and most rack systems are flexibly designed to accommodate varying sizes of equipment. A drawback of the flexibility racks provide is that the computer equipment is not adequately secured within the rack. This lack of security increases the risk of equipment theft and/or damage. In many companies this problem is addressed by keeping the rack in a secure room and limiting access to that particular room. A problem encountered when using this approach is that it can become cumbersome to determine who is and who is not authorized to access the equipment room. When outside vendors are involved in the configuration, maintenance, or testing of the computer equipment this problem becomes even more pronounced.

One solution used to address the problems discussed above is to secure the computer equipment held within the rack via a cable (See e.g., FIG. 1). When this solution is utilized Computer Equipment 100, 102, and 103 held within Rack 106 is secured via Cable 108. Cable 108 is attached to Rack 106 via padlock 110 and to Computer Equipment 100, 102, and 103 via a securing mechanism 112, 113, and 114. This approach secures Computer Equipment 100, 102, and 103 within Rack 106 but does not limit access to each individual piece of Computer Equipment 100, 102, and 103. A person that has access to Computer Equipment 100, for example, also has access to Computer Equipment 102 and 103. In some instances this may not be appropriate. If, for example, an outside vendor has provided the equipment on loan or for purposes of testing network performance, the outside vendor may not wish to allow network administrators within the company to change the configuration or placement of the equipment. Conversely, network administrators may wish to prevent outside vendors from changing the arrangement or configuration of certain equipment. Current systems for locking computer equipment within a rack do not adequately restrict access to individual pieces of equipment in a manner that securely the device, but is easy for authorized persons to unlock. As a result there is a need for an improved apparatus for securing computer equipment and other moveable objects held within a support rack.

### DESCRIPTION OF THE DRAWINGS

FIG. 1 shows an example of prior art mechanism for locking computer equipment within a support rack.

FIG. 2A is a front side view of the locking apparatus configured in accord with one embodiment of the invention.

FIGS. 2B-1 illustrates a perspective view of the locking apparatus configured in accord with one embodiment of the invention.

FIGS. 2B-2 illustrates a perspective view of the locking apparatus configured in accord with one embodiment of the invention.

FIGS. 2B-3 illustrates a perspective view of the locking apparatus configured in accord with one embodiment of the invention.

FIGS. 2C-1 illustrates a perspective view of the locking apparatus configured in accord with one embodiment of the invention.

FIGS. 2C-2 illustrates a perspective view of the locking apparatus configured in accord with one embodiment of the invention.

FIGS. 2C-3 illustrates a perspective view of the locking apparatus configured in accord with one embodiment of the invention.

FIG. 3 illustrates multiple perspective views of the locking apparatus configured with a rotatable obstructing member configured in accord with one embodiment of the invention.

FIG. 4A illustrates various obstructing members for blocking single points of egress/ingress from a support rack in accordance with one or more embodiments of the invention.

FIG. 4B illustrates an obstructing member for blocking multiple paths of ingress/egress from a support rack in accordance with an embodiment of the invention.

FIG. 5A is a front side view of an object containing contents to be secured in accord with one embodiment of the invention.

FIG. 5B illustrates a perspective view of the constraining and locking apparatus configured with the facia open in accord with one embodiment of the invention.

FIG. 5C illustrates a perspective view of the constraining and locking apparatus configured with both the facia and constraining apparatus open in accord with one embodiment of the invention.

FIG. 6A illustrates a perspective view of the constraining apparatus pivoting around an element attached to the object.

FIG. 6B illustrates a perspective view of the constraining apparatus pivoting around a hinge attached to the object.

FIG. 7A illustrates a locking apparatus with a rotatable locking element configured to prevent the constraining apparatus from opening in accord with one embodiment of the invention.

FIG. 7B illustrates a locking apparatus with a rotatable locking element configured to allow the constraining apparatus to open in accord with one embodiment of the invention.

### SUMMARY OF THE INVENTION

An apparatus embodying one or more aspects of the invention secures moveable objects such as computer hardware into position within a support rack by blocking one or more points of ingress and/or egress from the rack. An embodiment of the invention provides a mechanism for securing the moveable object into a fixed position within a support rack or any other system for holding such hardware. When the moveable object is locked within the support rack using the invention, an unauthorized party cannot move the physical object held within the support rack.

In one embodiment of the invention, the locking mechanism contains an obstructing member configured to block the opening of the support rack. The obstructing member contains an anchoring element disposed adjacent to any surface of the support rack located in proximity with the opening used to move objects from the support rack. The anchoring element contains a locking mechanism that provides an interface for coupling and decoupling the obstructing member. For example, anchoring element may be disposed adjacent to the support rack and the obstructing member may be removed via the locking mechanism so as to permit ingress and egress of objects to or from the support rack. The locking mechanism can be any device configured to couple and decouple the anchoring element from the obstructing member.

In one embodiment of the invention, the locking mechanism contains multiple components. For instance, the locking mechanism may be made up of a coupling element that protrudes from the anchoring element into the obstructing member's receiving element. The receiving element can be configured to capture the coupling element and thereby provide an interface for locking the anchoring element and the obstructing member. The coupling element may contain locking nodes which provide a mechanism for securing the coupling element to the obstructing member via the receiving element. In one embodiment of the invention the locking nodes provide an opening for inserting a securing element (e.g., a lock, padlock, combination lock, or pin, etc.) larger than the opening of the receiving element. When the obstructing member and anchoring element are coupled together via the locking mechanism, computer equipment or any other type of moveable object cannot be removed from the support rack. Thus, the invention provides a mechanism for locking moveable objects within a support rack.

In one or more embodiments of the invention, a constraining apparatus and a locking apparatus are disposed to control access and prevent the addition, removal or modification of the contents within an object. For example, circuit boards, or cards, may be locked to prevent addition, removal or modification by an access door of a container.

### DETAILED DESCRIPTION

The invention discloses a method and apparatus for securing devices within a support rack. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

An apparatus embodying one or more aspects of the invention secures devices such as computer hardware into position within a support rack by blocking one or more points of ingress and/or egress from the rack. An embodiment of the invention provides a mechanism for securing a device such as computer hardware into a fixed position within a rack or any other system for holding such hardware. The term computer hardware as used herein means any device or object, such as computer equipment, network equipment, telephone equipment, and/or any other computational device. The invention is capable of locking a moveable object within a support rack so that the physical object held within the support rack cannot be moved by an unauthorized party. The apparatus utilizes a locking mechanism to hold one or more devices within the support rack and thereby prevents the device(s) from being removed by unauthorized parties. There are multiple ways to build the apparatus described herein and the reader should note that the invention is not limited solely to the description provided. The claims and the full scope of any equivalent define the meets and bounds of the invention.

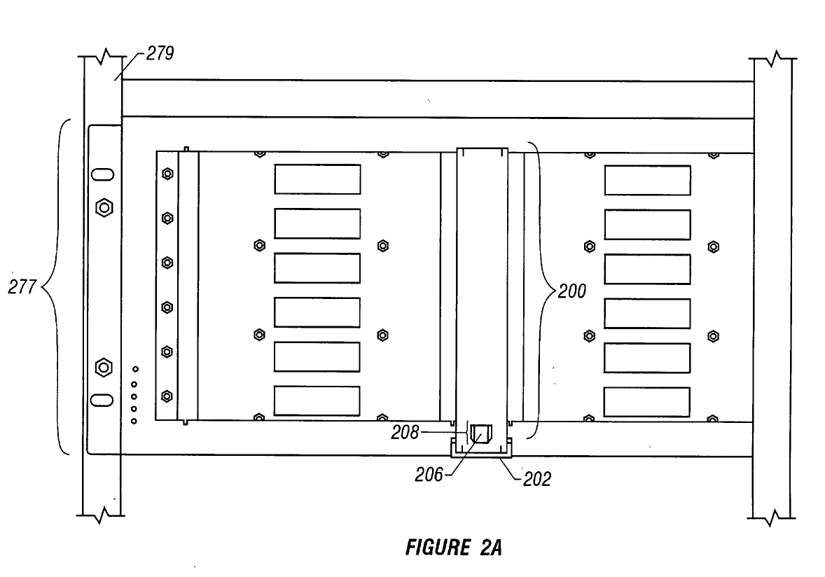

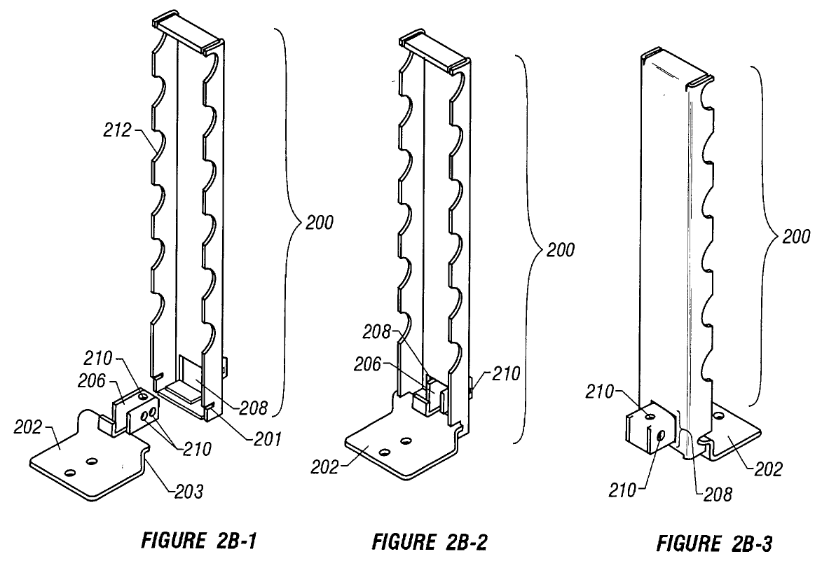

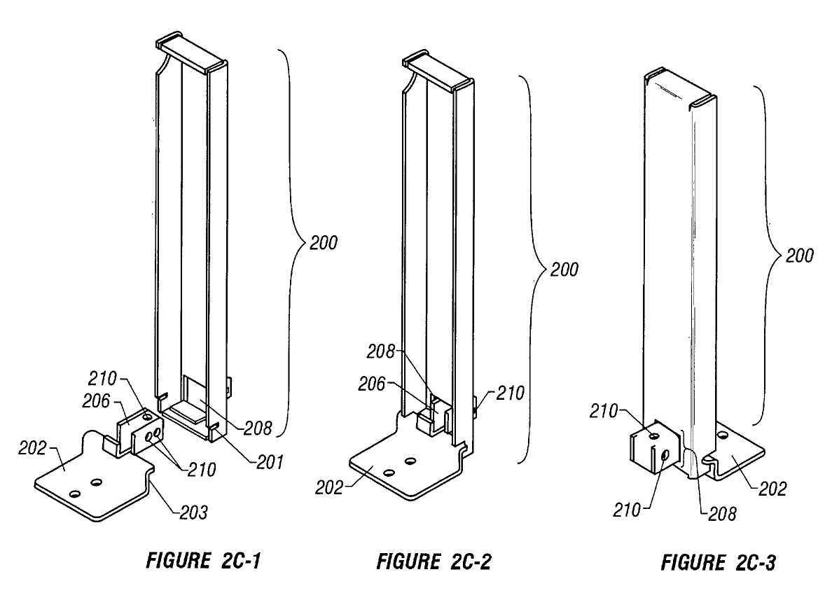

As FIG. 2A illustrates, the apparatus configured in accord with one embodiment of the invention provides a mechanism for locking any moveable object 277 (e.g., a piece of computer equipment) within support rack 279 via obstructing member 200 which can be positioned across or span any opening of support rack 279. An opening is considered to be any area that provides a point of ingress and/or egress for moving the moveable object into or out of the support rack. Obstructing member 200 may comprise one or more elements and can take any shape that deters removal of moveable object 277 from support rack 279.

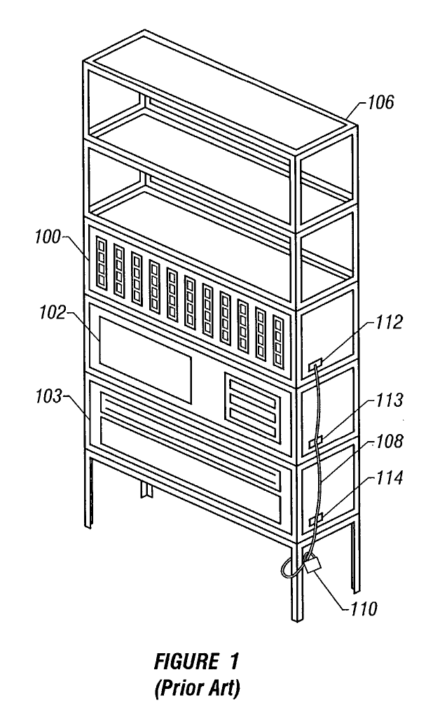

FIGS. 2B-1, 2B-2, AND 2B-3 illustrate obstructing member 200 in accordance with an embodiment of the invention. In this embodiment of the invention obstructing member 200 takes a generally rectangular form, but any other shape that can block the opening described above falls within the scope of the invention.

In one or more embodiments of the invention, obstructing member 200 is adapted to be securely connected to the support rack at one or more times, and adapted to selectively extend across or span an opening of the support rack at one or more times. Obstructing member 200 is designed in one embodiment of the invention to include an anchoring element 202 adapted to connect obstructing element 200 to the support rack. In one embodiment, the anchoring element 202 has a design which complements the shape-of at least one surface of the support rack. For instance, if support rack 279 is made of a series of geometric structures (e.g., a lattice), anchoring element 202 can be designed to couple with support rack 279 using a complementary shape. However, the shape of anchoring element 202 is not limited to solely to geometric shapes. Accordingly, the reader should note that anchoring portion 202 may contain any number of pieces and take any shape that can be coupled with the support rack. Anchoring element 202 is defined in accordance with at least one embodiment of the invention to be any object disposed adjacent to any surface of the support rack located in proximity with the opening used to move objects from the support rack. Anchoring element 202 may, for example, have a portion adhered to any aspect of the support rack. In one embodiment of the invention, anchoring element 202 is removeably or permanently a fixed to a vertical, horizontal, or other part of the support rack.

In one or more embodiments, anchoring element 202 is configured to engage obstructing member 200 in a manner permitting the obstructing member 200 to be oriented in a first position in which it extends across or spans an opening in the support rack to prevent access/removal of the moveable object 277, and at least a second position in which the obstructing member 200 does not extend across or span the opening, thus permitting access/removal of the moveable object 277.

In one embodiment, anchoring element 202 may contain a locking mechanism that provides an interface for coupling and decoupling anchoring element 202 with obstructing member 200. In this embodiment of the invention, anchoring element 202 is disposed adjacent to the support rack and obstructing member 200 may be removed via the locking mechanism configured to permit ingress and egress of objects to or from the support rack. The locking mechanism can be any device configured to couple and decouple anchoring element 202 from obstructing member 200.

In one embodiment of the invention, the locking mechanism comprises multiple components. For instance, the locking mechanism may be made up of coupling element 206 that protrudes from anchoring element 202 into obstructing member 200's receiving element 208. Receiving element 208 is configured to capture coupling element 206 and thereby provide an interface for locking anchoring element 202 and obstructing member 206 together.

In addition, in one embodiment, obstructing member 200 includes a notch 201 which is selectively engaged by a flange portion 203 of anchoring element 202. The engagement of flange portion 203 with notch 201 provides supplemental restraint of obstructing mechanism 200 in a position in which it extends across the opening in support rack 279.

Coupling element 206 may contain locking nodes 210 which provide a mechanism for securing coupling element 206 to obstructing member 200 via receiving element 208. In one embodiment of the invention locking nodes 210 provide an opening for inserting a securing element (e.g., a lock, padlock, combination lock, or pin, etc . . . ) larger than the opening of receiving element 208. Locking nodes 210 may also have protruding elements for holding anchoring element 202 in a locked position.

Various other locking mechanisms fall within the scope of what is contemplated by the invention. Locking mechanism may, for example, be any device or apparatus configured to restrict movement of obstructing member from an opening of the support rack.

In one embodiment of the invention anchoring element 202 is permanently coupled to obstructing member 200 and the locking mechanism interfaces with the support rack. However, as FIG. 2b depicts, anchoring element 202 may also be separable from obstructing member 200 via the locking mechanism.

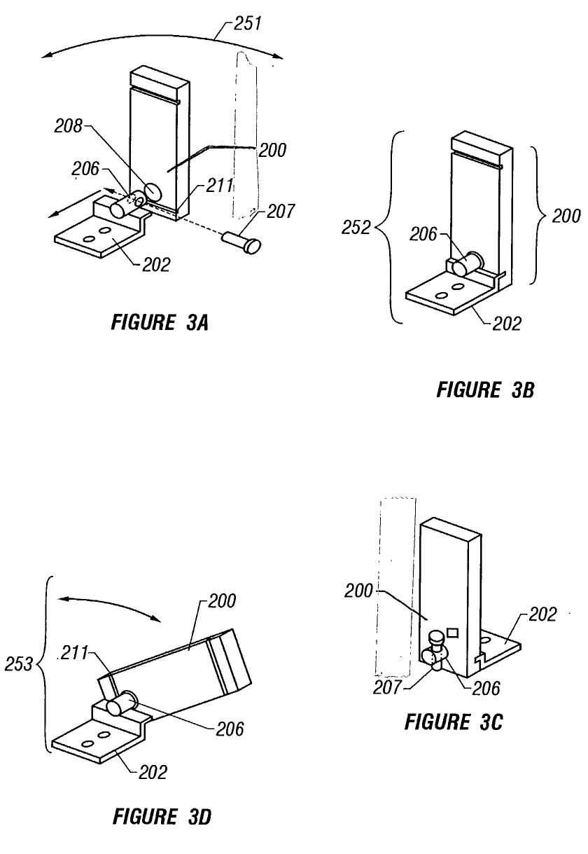

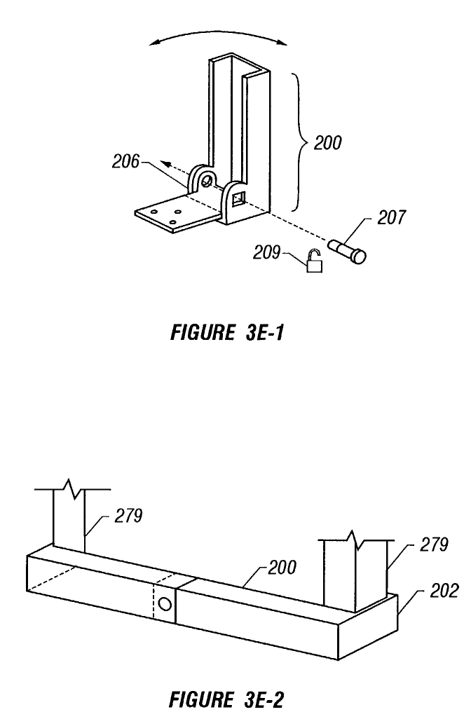

In one embodiment, obstructing member 200 interfaces with the support rack in a manner permitting pivoting or rotation of obstructing member 200 from the opening of the support rack during ingress and egress of the moveable object. For example, referring now to FIG. 3, obstructing member 200 is shown in a rotating embodiment of the invention. In this instance, coupling element 206 comprises a circular pin which allows rotation of obstructing member 200 as illustrated by directional arrow 251. When obstructing member 200 is in a locked position 252, moveable objects cannot be removed from the support rack. When obstructing member 200 is rotated to an open position 253 moveable objects can be removed from the support rack. Obstructing member 200 can be held in a locked position via inward pressure exerted when pin 207 is inserted so as to cause obstructing member 200 to engage with support rack 279. For instance, obstructing member 200 may contain a groove or notch (e.g., 211) that permits obstructing member to rest in an obstructing position when locked.

Obstructing member 200 may be movably connected to support rack 279 in other manners (See e.g., FIGS. 3E-1 and 3E-2). In one embodiment, anchor element 202 may include a passageway which is alignable with a passageway in obstructing member 200. Coupling member 206 may comprise pin 207 which can be extended through the aligned passageways. The pin may have a head at one end and an aperture at the other for accepting a lock 209 or the like to fix the pin in position. In one embodiment, pin 207 may be oriented as illustrated in FIGS. 3A-C, or rotated ninety degrees thereto, permitting obstructing member 200 to rotate towards and away from support rack 279, as opposed to side to side (see e.g. FIGS. 3E-1 & FIGS. 3E-2).

In other embodiments, the manner of connection of obstructing member 200 to support rack 279 permitting obstructing member 200 to be moved between its obstructing and non-obstructing positions may vary. For example, obstructing member 200 may be connected to support rack 279 with a hinge. In one embodiment, obstructing member 200 may comprise multiple portions which are adapted to engage on another. One end of each portion of obstructing member 200 may be connected to support rack 279, while opposing ends are adapted to selectively engage one another, such as in a locking fashion. When engaged and locked, the portions of obstructing member 200 may extend across or span an opening in support rack 279, while when disconnected, the opening is not obstructed.

In one or more embodiments, obstructing member 200 may be connected to support rack 279 in more than one location. For example, obstructing member 200 may be connected to support rack 279 at both, such as with anchor elements 202 at each end. Such attachment may be useful in preventing a party from attempting to bend or twist obstructing member 200 from its position extending across an opening of support rack 279.

In one embodiment, anchor element 202 and/or coupling element 206 may be integrally formed with support rack 279. For example, a pin may be formed as part of a rail of support rack 279, obstructing member 200 designed to mate with the pin in a manner permitting rotation as illustrated in FIG. 3.

As mentioned above, the shape of obstructing member 200 can vary throughout different embodiments of the invention yet still fall within the scope of what is contemplated as the invention. Obstructing member 200 may, for example, contain one or more resting portions 212. Each resting portion 212 may protrude from obstructing member 200 or as shown in FIG. 2b be notched into obstructing member 200. When resting portion 212 comprises a notch, the size (e.g., width and/or height) of the notch can be a varied or fixed width or height that coincides with the support rack to which it connects. For instance, in FIG. 2b the notches shown each have a substantially uniform opening size, however if desirable, both the sizes and the placement in supporting member 200 can be varied. In accordance with one embodiment of the invention, each resting portion 212 can couple with one or more portions of the support rack. Alternatively, as FIGS. 2C-1, 2C-2, and 2C-3 illustrate, obstructing member 200 does not require one or more resting portions 212. In this embodiment of the invention, obstructing member 200 contains a flat planar surface without notches or protrusions as described with respect to FIGS. 2B-1, 2B-2, and 2B-3.

FIG. 4A illustrates various obstructing members coupled with a support rack. Individual obstructing members 200 may be utilized to lock each individual moveable object 277 (e.g., computational devices) and can be positioned in any way that block the point of ingress and egress (e.g., vertical, horizontal, or at an angled position). Alternatively, as illustrated in FIG. 4B, obstructing member 200 can block the ingress and egress points for multiple objects 200 at the same time. Distribution of the keys for unlocking the locking mechanism associated with each obstructing member can be utilized to control access to the moveable objects. For instance, a vendor or employee may be permitted access to a certain moveable object and denied access to other moveable objects.

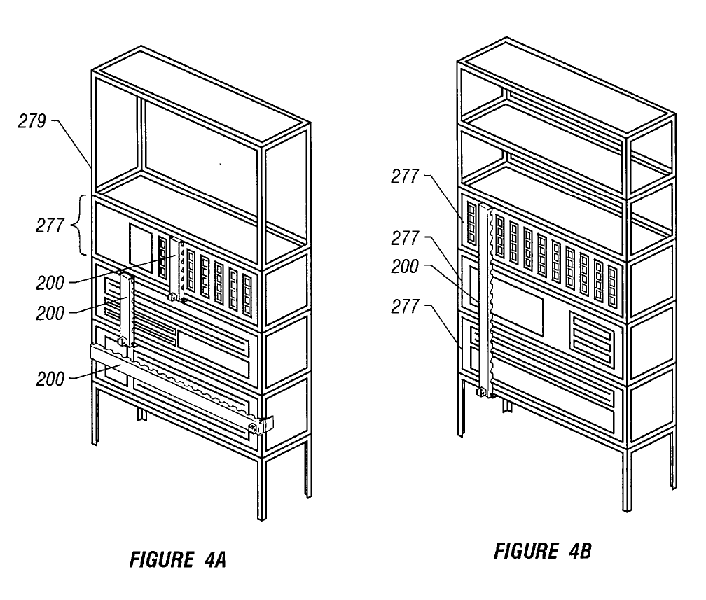

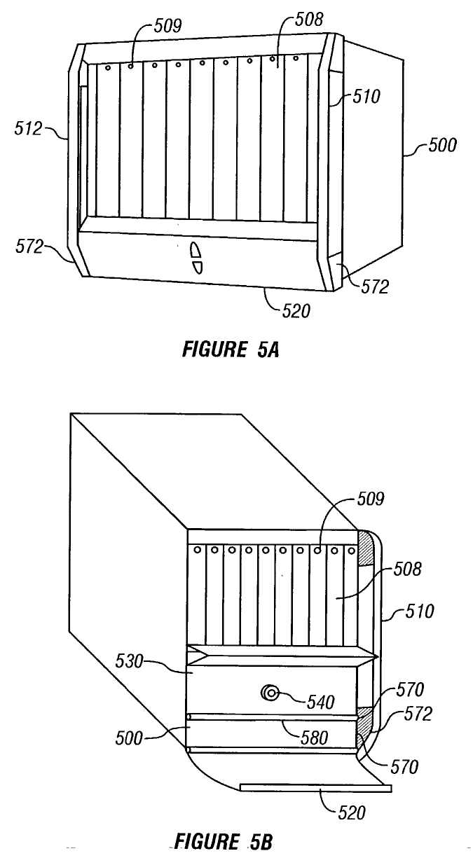

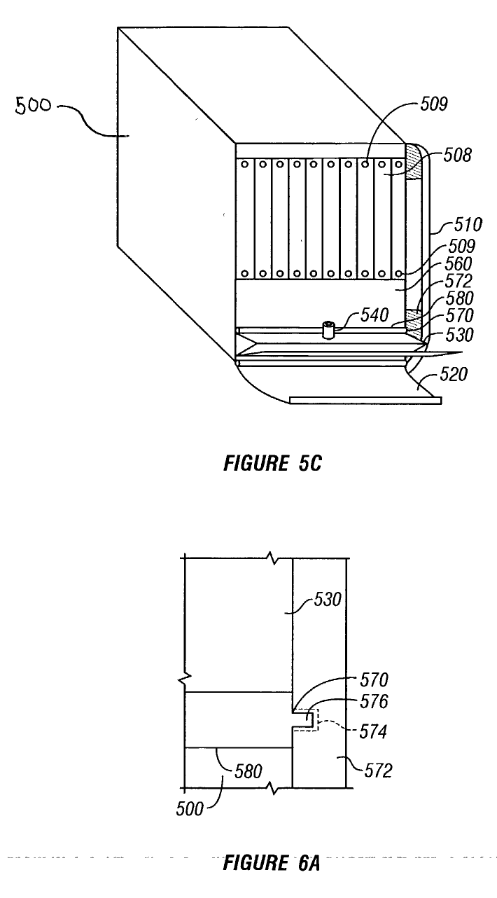

FIGS. 5A, 5B and 5C illustrate object 500 configured in accord with an embodiment of the invention, where a constraining apparatus and locking apparatus can control access to contents contained within the object. Object 500, containing contents, can be freestanding or mounted within support rack 279 in FIG. 2A.

FIG. 5A illustrates object 500 with right handle 510, left handle 512, walls 572 and facia 520 that conceals the constraining apparatus and locking apparatus for the constrained items 508. The constrained items 508 are attached at points 509 to object 500. In FIG. 5A, facia 520 is displayed in a closed position. In one or more embodiments, object 500 is a container.

In FIG. 5B, object 500 is displayed with facia 520 in an open position, so that constraining apparatus 530 is visible. In this embodiment, constraining apparatus 530 is represented as an access door and may be equipped with a locking apparatus 540. The constraining apparatus is shown as an access door for convenience but may take any other form that constrains the contents 508 of object 500. The constrained items 508 are attached at points 509 to object 500. Constraining apparatus 530 is fastened to object 500 and opens by pivoting around a portion or element 580 of the constraining apparatus 530 that is attached to the walls 572 of object 500 at points 570. Only right handle 510, containing wall 572, is displayed and left handle 512 has been omitted for clarity in FIG. 5B. Constraining apparatus 530 constrains contents 508 by blocking their removal at the bottom of contents 508. Constraining apparatus 530 blocks the removal of contents 508 by covering the lower part of contents 508 so that the contents cannot be removed when the constraining apparatus is closed. In one embodiment of this invention, contents 508 are circuit boards, or cards, and constraining device 530 is an access door that operates as a lock bar to hold the cards locked into place inside of a container.

In FIG. 5C, object 500 is displayed with both facia 520 and constraining apparatus 530 in an open position, so that the interior of the object 500 is visible through opening 560. The constrained items 508 are attached at points 509 to object 500. With constraining apparatus 530 in an open position, contents 508 of object 500 can be removed from the object. Constraining apparatus 530 may be equipped with locking apparatus 540. Constraining apparatus 530 is fastened to object 500 and opens by pivoting around element 580 of the constraining apparatus 530 that is attached to walls 572 of object 500 at points 570. Only right handle 510, containing wall 572, is displayed and left handle 512 has been omitted for clarity in the FIG. 5C. In the open position shown in this figure, constraining apparatus 530 does not constrain contents 508 by blocking their removal at the bottom of contents 508. As shown in this Figure, the contents 508 of object 500 can be removed. In one embodiment of this invention, contents 508 are circuit boards or cards.

Opening 560 in FIG. 5C is considered to be any area that provides a point of ingress and/or egress for moving the contents of object 500 into or out of the interior of object 500. In this embodiment of the invention, constraining apparatus 530 takes the form of an access door, but any other shape that can control access to the interior of object 500 falls within the scope of the invention. Similarly, facia 520 takes a generally rectangular form, but any other shape that can conceal the constraining apparatus described above falls within the scope of the invention. The use of constraining apparatus 530, without a facia 520, also falls within the scope of the invention.

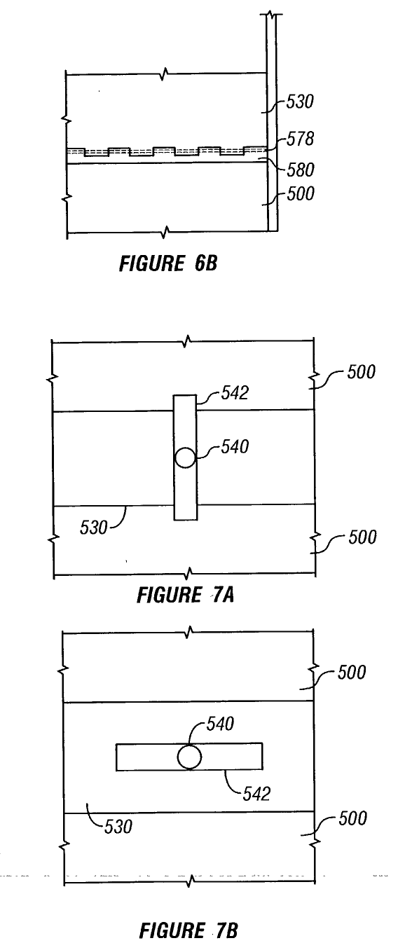

The attachment 570 between the constraining apparatus 530 and object 500 is shown in greater detail in FIG. 6A. In the Figure, element 580 of constraining apparatus 530 comprises a pin 576 that fits into a depression 574 in wall 572 of object 500.

Another alternative mode of anchoring the constraining apparatus to the object is shown in FIG. 6B, where the constraining apparatus comprises a first section of a hinge represented by 530. A second section of the hinge, anchored to object 500, is indicated by 580. A pin 578 holds the first and second sections of the hinge together. Any other alternative method of attaching the constraining apparatus 530 to the object falls within the scope of the invention.

FIGS. 7A and 7B show an embodiment of a locking apparatus for constraining apparatus 530. In one or more embodiments, locking element 542 of locking apparatus 540 is configured to engage object 500 in a manner permitting rotatable locking element 542 to be oriented in a first position, shown in FIG. 7A, in which it extends across or spans an opening in object 500 to prevent the constraining apparatus 530 from opening. In this first position, constraining apparatus 530 prevents access and removal of the contents of object 500. In at least a second position, shown in FIG. 7B, locking element 542 does not extend across or span the opening, thus permitting the opening of constraining apparatus 530 in order to access and remove the contents of object 500. As shown in the Figure, the locking element is a bar but any other locking apparatus for securing the constraining apparatus falls within the scope of this invention.

In one embodiment of the invention, the locking apparatus comprises multiple components. For example, the locking apparatus may be made up of elements comprising a telescoping bar that extends into or behind the side of object 500, when extended, to prevent the constraining apparatus 530 from opening. When the elements of the telescoping bar are retracted, constraining apparatus 530 can be opened. In one embodiment of the invention the locking apparatus provides an opening for inserting a securing element (e.g., a lock, padlock, combination lock, or pin).

Various other constraining and locking apparatuses fall within the scope of what is contemplated by the invention. Constraining and locking apparatuses may, for example, be any apparatus configured to restrict movement of object contents from an opening in the object. Any other alternative method for a constraining and locking apparatus to control access to the contents of the object falls within the scope of the invention. In one or more embodiments of the invention, the constraining apparatus may comprise a solid, a screen, a lattice, bars or any other obstruction that prevents entry or removal of components. In one embodiment, the constraining apparatus has an anchoring attachment element that has a design that complements the shape of at least one surface of object 500. The reader should note that a constraining apparatus anchoring attachment element may contain any number of pieces and take any shape that can be coupled with object 500.

The anchoring attachment element is defined in accordance with at least one embodiment of the invention to be any feature disposed adjacent to any surface of object 500 located in proximity with the opening used to move items from or to the opening. The anchoring attachment element may, for example, have a portion adhered to any aspect of object 500.

In other embodiments, the manner of connection of constraining apparatus 530 to object 500 may vary. For example, constraining apparatus 530 may comprise multiple portions which are adapted to engage each other. One end of each portion of constraining apparatus 530 may be connected to object 500, while opposing ends are adapted to selectively engage one another, such as in a locking fashion. When engaged and locked, the portions of constraining apparatus 530 may extend across or span an opening in object 500. When the portions of constraining apparatus 530 are disconnected, the opening is not obstructed.

In one or more embodiments, constraining apparatus 530 may be connected to object 500 in more than one location through connections that are removable. For example, constraining apparatus 530 may be connected to object 500 at several positions with locking mechanisms in place of hinges or pivots.

While an apparatus for securing moveable objects within a support rack has been described in detail, and numerous examples of its operation have been given, it will be appreciated by those of skill in the art that these are merely exemplary and that other implementations of these and various further aspects of the invention are also within its scope and extent. The invention is therefore not limited by the above exemplary description, but only by the following claims and the full scope of any equivalents.

What is claimed is:

1) An apparatus for locking a moveable object within a support rack comprising:
a first member positioned across an opening of a support rack, wherein said opening comprises a point of egress for a moveable object;
a second member having a first portion disposed adjacent with said support rack and a second portion removeably couplable with said first member so as to prevent movement of said first member and said moveable object via said point of egress.

2) The apparatus of claim 1 wherein said first member comprises at least one resting point.

3) The apparatus of claim 2 wherein said at least one resting point comprises a notch.

4) The apparatus of claim 2 wherein said at least one resting point comprises a protrusion.

5) The apparatus of claim 2 wherein said at least one resting point is positioned adjacent with a portion of said support rack.

6) The apparatus of claim 1 wherein said second portion of said second member is coupled with said first member via a means for locking.

7) The apparatus of claim 1 wherein said second portion of said second member is coupled with said first member via a locking mechansim.

8) The apparatus of claim 7 wherein said locking mechanism comprises:
an anchoring element disposed adjacent with said support rack;
said anchoring element comprising a coupling element configured to interlock with a receiving element in said first member.

9) The apparatus of claim 8 wherein said anchoring element is attached to said support rack via at least one anchoring point.

10) The apparatus of claim 8 wherein said locking mechanism is configured to allow rotation of said first member out of said point of egress.

11) The apparatus of claim 8 wherein said coupling element protrudes from said anchoring element.

12) The apparatus of claim 8 wherein said coupling element comprises locking nodes comprising at least one protruding element for holding said anchoring element in a locked position.

13) The apparatus of claim 8 wherein said coupling element comprises locking nodes comprising at least one opening for inserting a securing element.

14) The apparatus of claim 13 wherein said securing element comprises a lock.

15) The apparatus of claim 1 wherein said moveable object comprises a computational device.

16) The apparatus of claim 15 wherein said computational device comprises a performance analysis system.

17) The apparatus of claim 16 wherein said performance analysis system comprises a system for testing a computer network.

18) A system for locking a moveable object within a support rack comprising:
a support rack configured to store at least one computational device;
a locking apparatus coupled to said support rack, said locking apparatus comprising:
a first member positioned accross an opening of a support rack, wherein said opening comprises a point of egress for at least one computational device;
a second member having a first portion disposed adjacent with said support rack and a second portion removeably coupled with said first member so as to prevent movement of said first member and said at least one computational device via said point of egress.

19) The system of claim 18 wherein said first member comprises at least one resting point.

20) The system of claim 19 wherein said at least one resting point comprises a notch.

21) The system of claim 19 wherein said at least one resting point comprises a protrusion.

22) The system of claim 19 wherein said at least one resting point is positioned adjacent with a portion of said support rack.

23) The system of claim 18 wherein said second portion of said second member is coupled with said first member via a means for locking.

24) The system of claim 18 wherein said second portion of said second member is coupled with said first member via a locking mechansim.

25) The system of claim 24 wherein said locking mechanism comprises:
an anchoring element disposed adjacet with said support rack;
said anchoring element comprising a coupling element configured to interlocking with a receiving element in said first member.

26) The system of claim 25 wherein said anchoring elment is attached to said support rack via at least one anchoring point.

27) The system of claim 25 wherein said locking mechanism is configured to allow rotation of said first member out of said point of egress.

28) The system of claim 25 wherein said coupling element protrudes from said anchoring element.

29) The system of claim 25 wherein said coupling element comprises locking nodes comprising at least one protruding element for holding anchoring element in a locked position.

30) The system of claim 25 wherein said coupling element comprises locking nodes comprising at least one opening for inserting a securing element.

31) The apparatus of claim 30 wherein said securing element comprises a lock.

32) The system of claim 18 wherein said moveable object comprises a computational device.

33) The system of claim 18 wherein said computational device comprises a performance analysis system.

34) The system of claim 33 wherein said performance analysis system comprises a system for testing a computer network.

35) A system for locking a moveable object within a support rack comprising:
a support rack configured to store at least one computational device;
a locking apparatus coupled to said support rack, said locking apparatus comprising:
an obstructing member positioned accross an opening of said support rack, wherein said opening comprises a path of egress for said at least one computational device and said obstructing member comprises a receiving element;
an anchoring element having a first portion disposed adjacent with said support rack and a coupling element configured to interlock with said receiving element of said obstructing member, wherein said obstructing member prevent movements of said at least one computational device via said path of egress when a locining mechanism is locked.

36) The system of claim 35 wherein said obstructing member comprises at least one resting point.

37) The system of claim 36 wherein said at least one resting point comprises a notch.

38) The system of claim 36 wherein said at least one resting point comprises a protrusion.

39) The system of claim 36 wherein said at least one resting point is positioned adjacent with a portion of said support rack.

40) The system of claim 35 wherein said anchoring elment is attached to said support rack via at least one anchoring point.

41) The system of claim 35 wherein said locking mechanism is configured to allow rotation of said obstructing member out of said path of egress.

42) The system of claim 35 wherein said coupling element protrudes from said anchoring element.

43) The system of claim 35 wherein said coupling element comprises locking nodes comprising at least one opening for inserting a securing element.

44) The system of claim 43 wherein said securing element comprises a lock.

45) The system of claim 35 wherein said coupling element comprises locking nodes comprising at least one protruding element for holding said anchoring element in a locked position.

46) The system of claim 35 wherein said computational device comprises a performance analysis system.

47) The system of claim 46 wherein said performance analysis system comprises a system for testing a computer network.

48) A system for locking a moveable object within said support rack comprising:
a support rack configured to store at least one computational device;
a locking apparatus coupled to said support rack, said locking apparatus comprising:
a first member positioned accross an opening of a support rack, wherein said opening comprises a point of egress for at least one computational device;
a second member having a first portion disposed adjacent with said support rack and a second portion rotatably fixed with said first member so as to prevent movement of said first member and said at least one computational device via said point of egress.

49) The system of claim 48 wherein said first member comprises at least one resting point.

50) The system of claim 49 wherein said at least one resting point comprises a notch.

51) The system of claim 49 wherein said at least one resting point comprises a protrusion.

52) The system of claim 49 wherein said at least one resting point is positioned adjacent with a portion of said support rack.

53) The system of claim 48 wherein said second portion of said second member is coupled with said first member via a means for locking.

54) The system of claim 48 wherein said second portion of said second member is coupled with said first member via a locking mechansim.

55) The system of claim 54 wherein said locking mechanism comprises:
an anchoring element disposed adjacet with said support rack;
said anchoring element comprising a coupling element configured to interlocking with a receiving element in said first member.

56) The system of claim 55 wherein said anchoring elment is attached to said support rack via at least one anchoring point.

57) The system of claim 55 wherein said locking mechanism is configured to allow rotation of said first member out of said point of egress.

58) The system of claim 55 wherein said coupling element protrudes from said anchoring element.

59) The system of claim 55 wherein said coupling element comprises locking nodes comprising at least one protruding element for holding anchoring element in a locked position.

60) The system of claim 55 wherein said coupling element comprises locking nodes comprising at least one opening for inserting a securing element.

61) The apparatus of claim 60 wherein said securing element comprises a lock.

62) The system of claim 48 wherein said moveable object comprises a computational device.

63) The system of claim 48 wherein said computational device comprises a performance analysis system.

64) The system of claim 63 wherein said performance analysis system comprises a system for testing a computer network.
